(19) United States
(12) Patent Application Publication
(10) Pub. No.: US 2005/0223638 A1
(43) Pub. Date: Oct. 13, 2005

(54) Hot water apparatus and method for sustainable agriculture

(76) Inventor: Douglas LaVere Moren, Livingston, CA (US)

Correspondence Address: Douglas L. Moren, 6630 Dwight Way, Livingston, CA, 95334, US

(21) Appl. No.: 10/791,433

(22) Filed: Mar. 1, 2004

(51) Int. Cl. A01C 1/00

(52) U.S. Cl. 47/58.1 R

(57) ABSTRACT

A method of cultivating crops and cover-crops, interactively and sustainably, using a novel hot water apparatus. The apparatus enables the farmer to prepare a soil bed for planting with a no-till method that: controls nematodes and soil pathogens, promotes nutrient cycling of cover crops and organic materials, kills weeds and weed seeds, and cultivates healthy soil micro flora. A low-pressure (5-60 psi) hot water (120-209 F) delivery system, characterized by a flexible mat which evenly distributes water to the underside of the mat where an attached layer of material with a high water holding capacity saturates and conducts scalding water onto the weeds. A hot water recirculation and heat exchange system reduces water demands while maintaining a high thermo charge in the mat. After soil cools, plants or seeds are planted directly through the mulch of dead weeds or cover crop. Inoculation of soil of microbes promote soil health and crop production.

References Cited

| | | | |
|---|---|---|---|
| 6,655,082 | December, 2003 | Paltin | 47/1.42 |
| 6,073,859 | June, 2000 | Gorgens | 239/13 |
| 5,927,601 | July, 1999 | Newson | 239/1 |
| 5,946,851 | September, 1999 | Adey | 47/1.5 |
| 5,848,492 | December, 1998 | Brown | 47/1.44 |
| 5,776,422 | July, 1998 | Kawasaki | 422/307 |
| 5,575,111 | November, 1996 | Rajamannan | 47/58.1 |
| 5,553,414 | September, 1996 | Chapman | 47.1.42 |
| 5,433,758 | July, 1995 | Thompson | 47/58.1R |
| 5,430,970 | July, 1995 | Thompson | 47/1.5 |
| 5,406,747 | April, 1995 | Kiefl | 47.142 |
| 5,385,106 | January, 1995 | Langshaw | 111/127 |
| 5,366,154 | November, 1994 | Thompson | 239/13 |
| 5,297,730 | March, 1994 | Thompson | 239/13 |
| 5,287,818 | February, 1994 | Rajamannan | 111/200 |
| 5,189,832 | March, 1993 | Hoek | 47/1.44 |
| 5,020,510 | June, 1991 | Jones | 126/271.1 |

Foreign Patent Documents

| | | | |
|---|---|---|---|
| WO0207513 | January, 2002 | WO | AO1m21/04 |
| EP1186234 | March, 2002 | EP | AO1m21/04 |
| NZ335032 | December, 2000 | NZ | AO1m13/00 |
| WO9426102 | November, 1994 | WO | AO1m7/00 |

### BACKGROUND OF THE INVENTION

1. Field of Invention

This invention relates to the field of sustainable agriculture. More particularly it advances the use of a hot water production and delivery apparatus that displaces the need for expensive and dangerous herbicides and soil fumigants, while bringing natural processes into farm operations. The method that accompanies this device enables the recycling of organic matter and nutrients from a cover crop's root mass without the use of tillage, discing, plowing roto-tilling etc. unavoidably these mechanical methods of churning the soil, and busting sod, turns-up seeds near the surface to trigger new weed germination while breaking down the soil's structure and contributing to erosion. The invention herein leaves the soil's profile intact, while bursting plant cells and melting cuticle wax and causing mortality to weeds and the seeds of future weeds. At the surface of the soil the cover crop foliage is converted into mulch, flattened into a relatively dense mat, which helps to further suppress weed upstarts, retain soil moisture, prevent erosion.

This apparatus and method further addresses the field of sustainable agriculture by advancing the budding science of culturing the soil's ecosystem for improved health and performance. Both chemical and mechanical forms of agriculture have had a deleterious effect on soil ecology. The lack of biodiversity in these soils further increases vulnerability to soil born pathogens. Methods applied to this invention improve the variety and number of soil organisms that recolonize the substrate after it has been heat treated. Cultured microbe inoculum shows great promise.

The field of sustainable agriculture is further encompassed by this technology and method, because is improves the viability of local, small-scale and organic farming businesses by providing a cultivation system that facilitates crop diversity and varied harvest timing through non-chemical means. Because it accommodates solar energy usage and runs on renewable energy it can compete in production costs, while yielding food that's cleaner and not hazardous to the environment to produce. Local food security and local economic stimulus are also areas that this invention facilitates. The invention herein relates to the specific field of hot water pest treatments by advancing effectiveness, efficiency, and energy conservation.

2. Prior Art

### Vegetation and Weed Control

the use of hot water for control of plant vegetation is a relatively immature field. Use in mainstream agriculture has been inhibited by a number of problems: first, considerable volumes of hot water are required, as much as 2000 gallons per acre. In most cases the frequent refilling of the tank demands several time-consuming trips to and from the field, while the weight of the water and equipment contribute to soil compaction. Patents U.S. Pat. No. 6,505,437 and U.S. Pat. No. 6,047,900 describe a mobile system of spraying hot water on the ground under high pressure, followed with a hood like box and/or liquid foam (suds) to contain heat in the killing zone. However, both inventions use volumes of hot water in excess of what is actually needed. The reason, in part, is that prior art uses high pressure and high water volume to compensate for irregularities in the grounds contour. It is clear, improvements in this area can greatly advance the practicality of this technology.

Energy demands also hinder the wide spread utilization of hot water weed control, heating hot water with diesel, gas, or electricity from well water temperatures requires considerable energy input. Since chemical herbicides and the state of the art hot water vegetation systems are both dependent on energy prices, it is difficult or impossible for hot water to have a production cost advantage, unless hot water usage is made more efficient and/or if renewable energy sources are hybridized into the system. It is clear from patents and references, that if hot water weed control is to become popular and practical, against chemical herbicides, it must become more water and energy efficient, as well as safe, and it must, in its method of application become ecologically sustainable.

### Deep Soil Treatment

State-of-the-art in heating the soil as a means of controlling nematodes, insects, pathogenic fungi, viruses and bacteria, has gone in two different directions. In U.S. Pat. No. 5,141,059 the apparatus for heat generation is microwave energy. In U.S. Pat. No. 5,287,818 the inventor provides a method of applying microwave beat at greater and varying soil depths. Prior to these inventions, U.S. Pat. No. 5,259,327 describes a method of raising the soil temperature by heating hot water in a mobile boiler or heater and injecting it into the soil at varied depths as a means of producing sterilization temperatures consistent throughout the crop bed. Applied directly to the soil, microwave energy is described as superior because it is efficient in that it heats first the water and anything containing water. The organic molecules of the microbes and all other soil organisms are believed to be heated before mineral and soil particles—possibly creating an energy saving advantage over producing and applying hot water. The microwave applied directly on and into the soil as described by U.S. Pat. No. 5,622,123 is said to eliminate the need for transporting and heating water. However, ecological and economic sustainablity are in serious question for both the microwave and the hot water application system.

“Sterilizing” large continuous tracts of land and then, supplementing the soil with simple microbe inoculum is to quickly reduce the biodiversity of the soils ecosystem. In the last decade the study of soil ecology has evolved greatly, that we now know diversity in the soil, like diversity in a rainforest is key to healthy and sustainable production. Without this biodiversity in the soil, which includes vast numbers of species of Bacteria, protozoa, fingi, and algae, there is a greater likelihood that pathogenic organisms will find an easy foothold in the simplified agricultural soil and cause serious economic damage to the crop. “Because you treat you have to treat again and again.” This catch twenty two is well known in the chemical agricultural world, as fumigants like methyl bromide destroy soil diversity and make way for new orders of organisms—which are usually not to the farmer's favor. Hot water also has this same abuse potential, and could become a treatment treadmill that only leads to more soil simplicity, and ergo more vulnerability. It is clear that these problems must be overcome.

As to the microwave approach to heating soil, the verdict is still out, but recent research shows that the mutation effect of the microwave on the DNA and RNA of microorganisms is beyond the effect of heat alone. Thus potentially, a farming routine in which soil pathogens are treated with microwave heat, but never fully eliminated, could accelerate resistance through inadvertent artificial selection. Therefore, in addition to the threat of reducing biodiversity and productivity in the soil by misuse of heat, there is also the threat that the microwave heat system will facilitate pathogen resistance by providing the surviving population with a continuous variety of mutations.

In addition, the hot water soil treatment, as described in U.S. Pat. No. 5,622,123 also has potential for abuse, namely soil compaction from the weight of the water as well as heating and injection equipment. According to published research, pertaining to U.S. Pat. No. 5,622,123, increasing scale and thus increasing ground speed is a primary objective. However, at such pace there is difficulty in providing even heat and water distribution throughout the soil's profile. High water pressure and temperature in combination with equipment that churns and mixes the soil has been the strategy for addressing this problem, but apparently with limited success. Another conspicuous problem with the hot water soil treatment, U.S. Pat. No. 5,259,327 is weight. The large boiler size and application technology, along with large tractors, creates soil compaction. Energy consumption by the boiler is also excessive. Furthermore, cited hot water apparatus and methods require a soil-tilling preparation system, creating additional soil impact problems particularly the production of hard dirt clods. Increasingly, it is clear that the prior art is not the appropriate means of making hot water soil treatments practical and ecologically sound.

### SUMMARY OF INVENTION

The American pioneers found the great grass prairies rich with deep fertile topsoil. But putting it under the plow, busting sod and farming with a till system would lead to the erosion and destruction of farmland. The dust bowl is a well known example, but the problem persists today.

The apparatus and method described herein enables the farmer to use hot water in a no-till farming system that builds soil structure and facilitates healthy soil ecology. Not only does the invention herein eliminate the need for chemical herbicides and fumigants, it provides a foundation for a form of agriculture that achieves sustainablity and productivity by utilizing the biodiversity of crops, cover crops and the soil.

Rural cities like those in the great Central Valley of California are surrounded by fertile farmland, however, the average food product merchandised and consumed in those towns is not of local origin, but shipped in an average of 1000 miles. This conventional food distribution system contributes to congested roads, and excessive trucking means excessive pollution in a valley that already ranks second in the nation for bad air. If food were produced and consumed more locally, quality of life would be dramatically improved, not only from cleaner air but also better nutrition, stronger local economies, greater ecological stability and a more reliable food security program. However, several obstacles hinder these improvements, particularly the difficulty of competing against large industrial scale agriculture and franchise food corporation. The apparatus and method herein over comes this obstacle by enabling local farmers to competitively grow small quantities of a great variety of crops, in a staggered production system that yields an appeasing variety of fresh and value-added foods at all times. In addition, the invention herein also advances small scale farmer's ability to grow food with ecological sustainablity and “organic” quality. It is also apparent through consideration of the objects of this invention that existing problems associated with state-of-the-art hot water for weed and soil pathogen control systems can be ameliorated.

### OBJECTS OF MY INVENTION

Object #1, Hot Water Application Device. A flexible insulated mat is pulled over the soil or vegetation. The mat has a water absorbent material layered on its underside which is maintained at complete capillary saturation and high temperatures by the flow of water from multiple tube outlets in the mat. As water sops through the matt from low pressure and gravity it provides a charged heat mass that improves the efficiency of energy and water usage in both vegetation and soil pathogen control. For example, when a topical application for vegetation control is desired, the mat improves the process by providing a substantial heated mass to the target plants, instantly. A savings is made because heat conduction from this charged mass (160 F) is rapid and amply hot to melt the plant's waxy cuticle and induce mortality. The insulation of the mat prevents the heat in the saturated material from escaping to the sky, and in combination with the high heat and mass of this material, a forced conduction circumstance is provided in which heat entering the vegetation is accelerated, reducing the need for hot water saturation of the soil. The sopping of hot water into the soil at all points along the undersurface creates an air presure blitz that forces hot air and steam into the soil. Saturation of the soil with hot water is not necessary and therefore a smaller volume of water is required to perform the task.

When programmed to perform a deep soil treatment for nematodes, soil pathogens and deep-rooted weeds like bermuda grass, the sopping hot mat helps to overcome problems of heat penetration and distribution with an entirely different strategy than prior art. Rather than adhering to an extended economies-of-scale design-objective, employing large equipment which tills and mixes the hot water and soil together while striving for maximum ground speeds, the invention herein takes a simple approach of not tilling the soil prior to or during the treatment, but relies on root permeation of a preceding cover crop (or weeds) to improve water penetration and heat distribution. The mat is pulled along the surface of the soil bed at a much slower pace than topical applications. The thermodynamic features that provide improved heat distribution in a topical application also improves effectiveness in deep applications.

Object of Invention #2

The object of this invention is the means by which the mat is pulled along the surface of the vegetation. One version will be a mobile base that is moved to the field location, and which retrieves the mat by reeling it in with a winch tool that rewinds hose and line. In another version said mat is mounted under a low deck possessing four wheels. On the deck is a variable geared winch that pulls the entire unit along by rewinding a staked rope or cable while retracting or unwinding the hot water supply hose. An even more complex unit includes a backup heating system on board that makes up for any temperature inadequacies of the incoming water. Still, a a simpler version uses the incoming water pressure to turn a turbine that retrieves said mat. In addition the matt can be mounted on a tractor, particularly in the case of topical application where significant ground speeds can reached. However, there are several advantages in using a automated creeping unit, particularly when a cover crop is grown, then thermo harvested, then planted with a cash crop through the mulch. This no till system not only reduces the number of steps in the crop production process, (compared to conventional farming or prior art) but does a more thorough and energy efficient job of treating the soil and cover crop than a tractor mounted unit, geared for high ground speeds. A reduced need for tractors and reduced tractor hours represents a cost-competitive opportunity for the farmer.

Object of Invention #3

The object of this invention heats and delivers the water to the mat's retrieval base or directly to the mat. Its design overcomes over comes the need for high ground speed by programable automation and does not require a tractor, driver or even a constant attendant. In one ideal scenario the farmer or worker can set the cable, predetermining the mat's swath, then go about planting recently treated swaths, and/or harvesting crops from swaths planted weeks earlier. Another reason that fast ground speeds are not essential, stems from the fact that the apparatus and method are designed to create production advantages for local small-scale community based food systems. This form of agriculture, requires the planting of a variety of crops through time. Therefore the conventional method of preparing and planting the entire field at once is inappropriate to meet targeted market demands. With a slower ground speed pace as an actual advantage, further improvements in cost performance are incorporated into this object for hot water production and delivery, in particular a preheat solar system.

### BRIEF DESCRIPTION OF THE DRAWINGS

FIG. 1 is an elevated and condensed perspective of the novel apparatus and method used in agricultural production.

FIG. 2 is a perspective drawing illustrating the components of the apparatus

FIG. 3 is perspective drawing illustrating the hot water application mat and its components.

FIG. 4 is a perspective drawing showing the hot water application mat, water plumbing and microwave heat supplementation system.

### DETAILED DESCRIPTION OF THE INVENTION

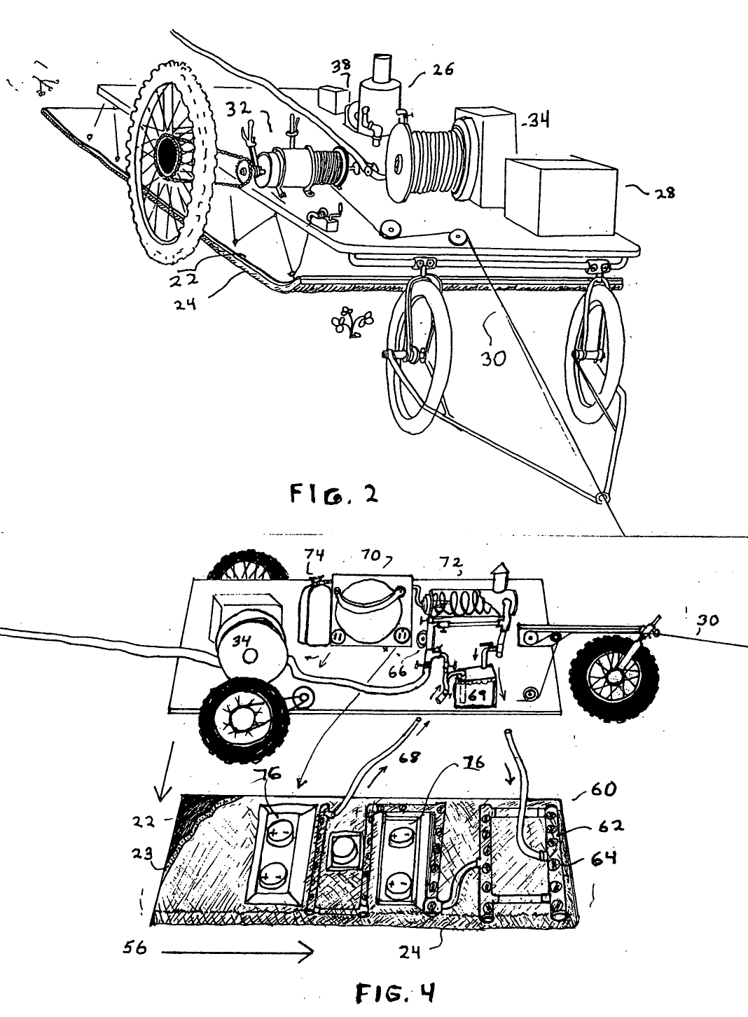

The method and apparatus of this invention utilizes the principles of thermodynamics to improve the effectiveness and cost-effectiveness of hot water as a medium for preparing agricultural soils. Referring to FIGS. 2 and 3, an electric motor 32 provides mobility via wheel traction or the reeling-in by a wench and cable 30. A hose 35 feeds preheated or ambient temperature water to a hose spool 34 that lets out hose or retracts hose as the mobile unit moves through the field. Water travels from the spool to the water heater 26 where target temperatures are achieved before continuing to the application mat. Hot water (120-209 F) is piped to the mat 60, where copper tubing is imbedded in the layer of fabric 24 or material possessing a high water holding 24 capillary capacity. Water emitters 64 along the tubing provide an even and controlled distribution of the hot water into the water absorbent material of the mat. A layer of flexible material 22 such as rubber and under it a layer of flexible insulation 23 both restrict the heat from escaping upward as a continuous supply of hot water saturates and thermally charges the water absorbent portion 24 of the mat. As the mobile unit pulls the sopping hot mat along the surface of the vegetation, plants are killed either by melting the waxy cuticle, which results in death by dessication, or at higher temperatures, where cells explode and instantly expire from the heat's intensity.

The advantage of this novel application mat further becomes apparent when examining FIG. 4 where a return hose 68 from said mat returns water to a reservoir 69 onboard the mobile unit. The water is reheated 26 and recycled via a low pressure pump 66 back through the mat. When emitters 64 are adjusted for lower flow the high temperatures of the mat can be maintained because the copper tubing in contact with the wet mat provide excellent heat transfer through conduction and convection. Heat transfer is also enhanced by the heat curve as near boiling water delivered to the mat releases latent heat. The result moderates the problem of using too much water to be a practical technology for commercial agriculture, because heat and the water volume are separated at the mat, creating a situation where water usage can be reduced, while the available heat is increased. To further improve this efficiency FIG. 4 illustrates the use of microwave generators 76 providing supplemental thermo energy by exciting the water molecules in the mat 24.

Utilizing the heat carrying capacity of the sopping hot mat 60, the specific treatment of weeds at the surface (topical) can be quick and efficient. Thus, said mat and water heating system 26, 68 can be pulled through the orchard or field behind a tractor or other vehicle at a conventional pace. However, the design of the machine and method enable a variety of other services that require a much slower and controlled pace. Many of those services, can be implemented simultaneously in a single application that eliminates several independent steps typically employed by conventional agricultural production. For example, rather than tilling the soil, weeds or cover crops can be directly converted by the heat to dead and decaying biomass, accelerating nutrient release of the organic materials. Heat treatment at a greater depth, though at lower temperatures (150 F), kills nematodes and other soil pathogens. Putting these deleterious organisms at bay, then inoculating the soil with a vast spectrum of beneficial organisms is a key strategy of this invention that improves soil health and productivity while reducing production costs. The same treatment also replaces pre-emerge herbicide applications by thermally killing weed seeds at or near the soil's surface. After planting, crops additionally benefit from residual warmth in the soil.

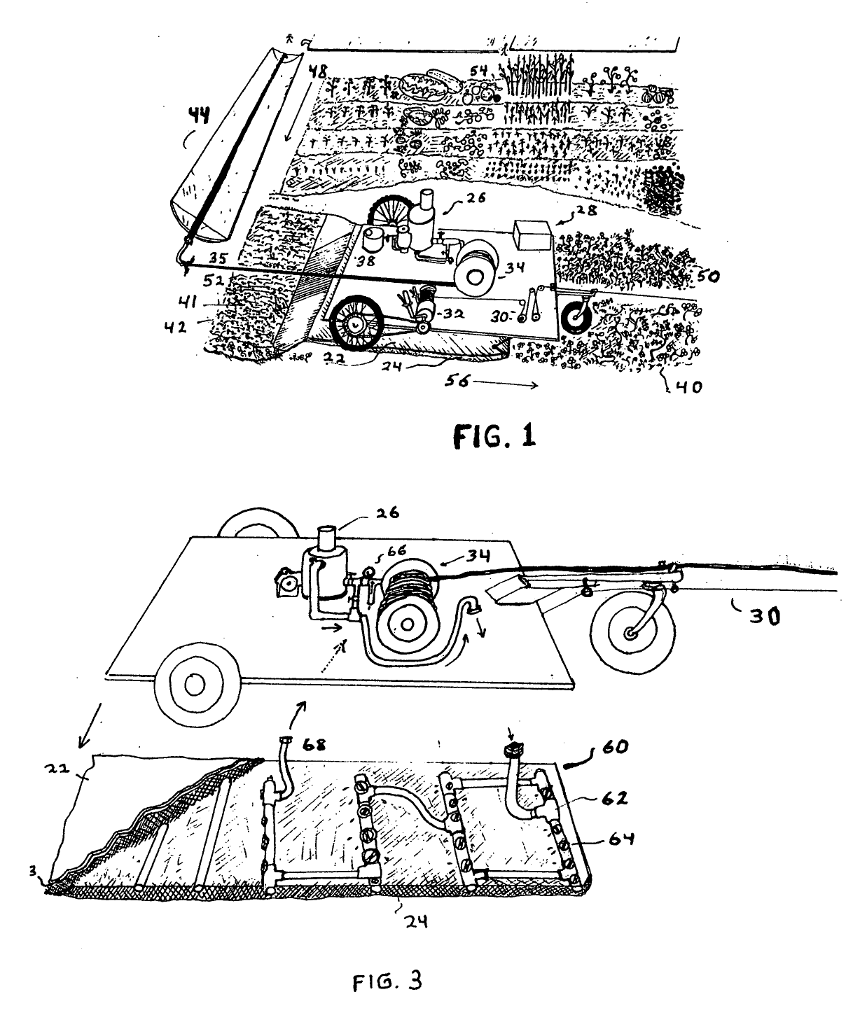

The invention is designed to facilitate a method where covercrops such as clover, vetch and grasses are grown for their biomass and nutrients, then converted to a planting bed by the application of the sopping wet heat mat 60. The unit obtains high cost efficiency in these circumstances since it does not require a constant operator. The cable 30 is stretched along and staked to designate the path the unit will travel. A low geared electric motor 32 with a variable speed control and/or a pulley arrangement FIG. 1, 30 along the cable retraction guide provides a wide range of speeds and leverage for the movement of the invention. A number of factors determine the exact speed of the application; e.g. the soil type, sand as apposed to clay has faster water penetration and a lower specific heat than clay. Therefore sandy soils take less water and energy to reach ideal treatment temperatures. A well established cover crop FIG. 1, 40 or weeds 50 with good root development dramatically increases water penetration of the soil, reducing application time and speeding the progress of the unit. Other factors include, ambient soil temperature, flow volume and soil moisture. At present the best strategy for calibrating the application is by measuring the progress of temperature rise at various depths and then adjusting the speed at which the unit travels by means of the variable speed control of the electric motor and/or by positioning the cable's pulley ratio.

FIG. 1, 56 indicates the direction of movement of the unit. FIG. 1, 48 illustrates an exaggerated time line of successive heat applications and crop 54 plantings. FIGS. 1, 46 and 44 illustrate the use of solar collectors as a water preheat system. FIGS. 1, 41 and 42 depict heat treated area of dead cover crop or weeds as a mulch. The method entails building organic matter for fertility.

At the time of writing this patent for said invention hydrogen electric technology is rapidly nearing commercial availability. As it does hydrogen technology becomes the ideal and preferred embodiment due to the distinct advantages it provides to thermo aqueous agriculture and specifically to my novel sopping heat mat apparatus and process. For example, hydrogen can be burned and copper water-coils 72 heated, the exhaust; heat, water can be routed to the heat treatment area—to make use of thermo energy otherwise lost in fossil fuel systems. And, since thermo electric 70 conversion will soon be available, electricity and flame can be used interactively, providing hot pipped water, microwave 76 supplemental energy for the hot sop mat, electricity for traction 32 and cable guidance system 30 motor, and for electric water pumping 66. All functions on this invention can be performed from the same clean fuel source, hydrogen. Further, hydrogen technology will soon make on-farm production of hydrogen gas practical, giving thermo aqueous agriculture both environmental and economic advantages over conventional agriculture.

Utility of said invention gains clarity when considering that American farmland has lost much of its topsoil. The organic matter of the soil, a vast reservoir of energy that once stretched across the nation was spent by the plow producing wheat, corn and soy. However, the famines which typically follow soil exhaustion and erosion, as happened across Europe for centuries of wheat culture, were avoided in America because of the 1960s green revolution's when petroleum based fertilizers inexpensively replaced the need for natural soil fertility. Unfortunately, oil is very inefficient, about ten calories of petroleum go into producing one calorie of food. Our dependence on oil products for agricultural success invites food security and economic stability problems and seriously needs addressing on the grass roots level. Meanwhile, modern farming systems largely remain the plow and till system, as we continue to loose top soil.

The invention herein provides an alternative that can be used with said method to increase organic matter in the soil, create self renewing fertility, and self sustaining crop production. This entails producing crops in strips where cover crops have been grown and heat treated by said invention, converting it to micro-flora fodder and mulch and ultimately as food for the cultivated crop. In between are strips of live cover crops alternating with strips of crops plants. The width size of the two strips and their ratio to each other vary according to the crop and cover crops planted, and therein provides an opportunity to accelerate organic matter production for the soil. For example, in a dense stand of clover, alfalfa and bermuda grass, every twelve feet there is a 24 inch wide strip of thermally terminated cover crop. In this case, the treatment is semi deep (6+ inches) and at moderate temperatures 150-160 F. When beneficial soil microbes and watermelons are established in the treated strip the watermelon vines will easily grow over all of the 12 feet separating the strips. A fast topical hot water treatment, can be used to suppress cover crop growth near the young vines long enough to give the water melons a head start. Hot water treated plants bleach bright and reflect more light and promote faster plant growth. In this growing arrangement there is an overlapping of one specie's vines and another's species roots. This is similar to nature's fertile and self perpetuating eco-systems which are rich because they are complex and multilayered. A comparison to conventional system farm system where crop rotation means entire fields are left fallow or planted with cover crops, while commercial crops are planted in other fields in mono-culture fashion. But in said invention and method, intercropping of diverse cover crops and crops in the same field improve productivity by maximizing the leaf area of the crop (e.g. melon) while expanding root production, nitrogen fixation and organic mass from cover crops. The crop next season will be planted in an area that is now a cover crop, and since, in the case of melons, there is a ratio of 6 to 1 of cover crop to crop area, the complete rotation cycle is 6 to 7 years.

The mat 24 must have the ability to exchange heat yet maintain high heat mass at a high temperature 150 209 F. This is accomplished by having a woven fabric like woven polyethylene, or woven hemp that has a high water holding capillary capacity and can maintain sopping wet conditions as the hot water moves through material.

Producing the thermo energy from solar and hydrogen to do work that is normally performed by tractors, plows and tillage tools, herbicides and fumigants yields sustainable production units and greater profitability because it can be certified “organic”.

Having thus described the invention in its preferred embodiment thereof, it will be evident to those skilled in the art that modifications and revisions can be made to the method and apparatus described herein without departing from the spirit and scope of the invention. For example there are dozens of other types of water observant fabrics and weaves, even some “welcome mats”, that will be suitable as a hot water application mat. And, a heat pump as well as a microwave can be used to concentrate temperatures in the mat. But the principle, spirit and scope of the invention centers on using water's high specific heat, its great heat carrying capacity, to produce a blitz of wet heat on target plants. This includes using the mat as a heat exchanger, as a means of reducing water usage, yet maintaining high temperatures and lethal wet heat. The spirit and scope also includes a method in which the biomass of a cover cropping scheme is harvested by said hot water invention in a no till system as the cover crop system solves water penetration problems via root penetration. However, it can also be used in combination with a till system. Crop seeds or transplants are planted through the dead mulch, and mixes of beneficial microbes, possessing diversified soil micro flora are included in the inoculum. Mycorrhizal fungi are also used where crop plants have fungal partners. Alternating strips of cover crop and heat treated areas create an opportunity to preserve and perpetuate soil microbe diversity.

1 A novel wet heat application apparatus for agricultural soil preparation and vegetation management, comprising;
a water absorbent mat with high water capillary capacity, charged and maintained with thermo energy by continuously saturating fabric with hot water (120-209 F), and, by conductive heat exchange through pipe walls and into the wet mat by cycling water from heater through the mat repeatedly.
a flexible, heat insulated and water impermeable liner that lines the top surface of the thermally charged water absorbent mat and blocks the heat from escaping up and outward. While in direct physical contact, the mat sops hot water onto the vegetation and into the soil, creating a thermo conduit from the heat charged mat to the heat targeted areas, improving hot water treatments for killing weeds, soil pathogens and nematodes.

2 The wet heat apparatus as claimed in claim 1, further comprising a low pressure (5-60 psi) main water line entering the mat, branching as copper tubing that distributes the incoming hot water throughout said mat and saturates adjacent capillary material. The mat is thermally charged 120-209 F and maintained at high temperatures by replenishment of hot water and by conduction of heat through the copper tubing of the mat as water cycles through the heater and back to the mat continuously. Water flow into the capillary material is adjustable by emitters along the conductive water tubing, as water consumption can be turned down and reduced while applied thermo energy is increased through heat exchange.

3. A wet heat apparatus as claimed in claim 2 further comprising a means of mobility and precision for hot water applications, via a multi wheeled unit that suspends said water absorbent mat in the undercarriage of said wheeled unit while traveling to field locations, and lowers said water mat onto plant bed and pulls said mat along the surface at the appropriate speed. An electric motor provides said wheeled mobile unit with wheel driven traction for traveling primarily to field locations, and a cable-pulled mobility system for control of said mobile unit's application location and application speed.

4. A wet heat apparatus as claimed in claim 3 further comprising a means of preheating water with remote solar collectors and distributing preheated water to said mobile unit through a flexible hose that retracts onto a spool or extends from the spool, according to the location of the incoming water source, and, an onboard back-up heater that thermostatically targets the appropriate temperatures, and a pump that cycles hot water to the application mat and back through the heater.

5. A novel wet heat and hot water application device and method that improves agricultural soil preparation and vegetation management of commercial farms, comprising:
A water impermeable, insulating and flexible liner that conforms to the contour of the land's surface, and has attached to its undersurface a water absorbent mat that posses a high capillary water holding capacity, and when hot water is distributed throughout said mat, said capillary material saturates, providing hot water or intense wet heat as said mat is slid across surface vegetation and soil as a means of killing plants, soil pathogens and nematodes.

6. A wet heat apparatus as claimed in claim 5, further comprising a pipe configuration with adjustable water emitters embedded throughout said mat as a means of distributing hot water to multiple points of capillary distribution.

7. A wet heat apparatus as claimed in claim 5, further comprising a hot water feed from a heater to said mat and a return “cooled” water line though a storage tank, then back though heater and mat, repeatedly, providing means of reducing the amount of water used in weed kill applications by turning down the flow of said water emitters in said mat and increasing the flow of cycling water and conductive heat exchange between heater and mat.

8. A wet heat apparatus as claimed in claim 5 further comprising: a mobile wheeled unit that supports and suspends said mat in the undercarriage of said unit, and raises the mat for transport and lowers the mat and pulls the mat across live vegetation at a controlled speed (0.25 inches per minute to approximately 2 mile per hour) for each specific wet heat application. An electric motor, winch and cable. Said cable threads through a pulley system with adjustable ratio options, where the cable then extends through a front wheel steering terminal and stretches across the area designated for heat treatment. A stake or anchor attached to the cable is inserted into the ground and as the winch retracts against the anchor, pulls said mobile wheeled unit and hot mat.

9. A wet heat apparatus as claimed in claim 8, further comprising, a spool mounted on said mobile unit that provides the means of retrieving or unreeling the incoming hot water hose line as the working mobile unit travels across treatment area.

10. A wet heat apparatus as claimed in claim 7, further comprising: A microwave generator mounted on the top of said wet mat and charging said mat with thermo energy, as a means of reducing water usage while maintaining high wet-heat temperatures.

11. A wet heat apparatus as claimed in claim 7, comprising a small heat pump further removing heat from circulating water and depositing it in said wet mat as a form of supplemental heat.

12. A wet heat apparatus as claimed in claim 8, further comprising a moveable solar hot water preheat system, connected by said hose and spool, with a backup heater onboard said mobile unit, provided with thermostatic controls that enable the backup heater to compensate for discrepancies between solar output and target application temperatures.

13. A method and apparatus to improve the ecological and economic sustainablity of farming systems, comprising A flexible mat with high water absorption and capillary water suspension capacity. Said mat is charged with thermo energy by a continuous saturation of hot water (120-209 F) A flexible, heat insulated and water impermeable liner covers the top surface and the sides of the thermally charged mat and directs the heat downward. Hot water sops from to the under surface of saturated mat by gravity and capillary flow, onto the plants and into the soil, raising thermo conductivity of the substrate and increasing the amplitude at which the mat discharges its thermo energy. A means of wheeled mobility is provided, with which said mat is pulled along the surface of said plants and soil at concise speeds and locations for specific types of hot water and wet heat applications.

14. A wet heat apparatus as claimed in claim 13, further providing a means of mobility and guidance, comprising a mobile unit or wagon with wheels and a carriage, an electric motor and winch with a cable that retracts to pull and guide wagon along a designated course. The mobile unit supports and suspends said mat in the undercarriage and raises the mat for transport and lowers the mat and pulls it over live vegetation at a controlled speed (0.25 inches per minute to approximately 2 mile per hour) for each specific wet heat or hot water application. Said electric motor or a second electric motor provides mobility and speed control to and from the treatment site, through wheel traction via a chain drive or a differential.

15. A wet heat apparatus as claimed in claim 13, further comprising a means of providing said mat with hot water and supplemental heat. An onboard heater, (gas, biodiesel, electric or hydrogen) raises the temperature of incoming water, a low pressure water pump (5-60 psi) circulates hot water through the mat and back through the heater via a small storage tank. Water emitters located along the tubing throughout said mat saturate the mat with heat and water. Hot water not emitted into said mat releases heat energy through pipe walls into wet mat before returning to heater.

16. A wet heat apparatus as claimed in claim 15, further comprising a method that reduces the amount of water used in weed soil pest-kill applications by means of turning down the flow of water emitters in said mat and increasing the flow of cycling water and conductive heat exchange between heater and mat.

17. A wet heat apparatus as claimed in claim 13, further comprising, a spool mounted on said mobile unit that provides the means of retrieving or unreeling the incoming hot water hose line as the working mobile unit travels across treatment area.

18. A wet heat Apparatus as claimed in claim 13, further comprising an insulated apron attached to the rear section of the said mat as a means of containing treatment heat.

19. A wet heat apparatus as claimed in claim 13, further providing a method for cultivating crops and cover crops, interactively and sustainably, comprising the following steps.
A. cultivating a cover crop on a prospective field, (legumes, rye grass, weeds, etc.)
B. spreading compost over cover crop or the weeds of a selected soil bed.
C. applying hot water (120-209 F) with said hot water application technology to soil bed at depth and temperature prescribed for the specific crop and soil treatment.
D. planting crop and introducing beneficial soil organisms after soil has cooled.
E. cultivating cover crops and organic matter between treated crop strips
F. Rotating crops with cover crops
Wherein, the wet heat apparatus improves the effectiveness and efficiency for killing weeds, soil pathogens and nematodes, (i.e. pests) promotes nutrient cycling of cover-crops and organic materials, kills weed seeds, and cultivates healthy soil micro flora, there are several possible variations to the described invention herein that are consistent with the spirit and intent of these claims.
